(19) United States
(12) Patent Application Publication
(10) Pub. No.: US 2026/0166862 A1
(43) Pub. Date: Jun. 18, 2026

(54) PROCESS FOR MANUFACTURING FLOOR OR WALL COVERINGS, AND ASSOCIATED COVERINGS

(71) Applicant: GERFLOR, LYON (FR)

(72) Inventors: Freddy BOSC, LYON (FR); Patrick RAMUET, LYON (FR); Jessica MULLER, Tarare (FR)

(21) Appl. No.: 19/124,368

(22) PCT Filed: Oct. 25, 2023
(86) PCT No.: PCT/FR2023/051677

§ 371 Date: Apr. 25, 2025

(30) Foreign Application Priority Data
Oct. 25, 2022 (FR) FR2211096

(51) Int. Cl. B32B 27/08; B32B 7/12; B32B 27/12

(52) U.S. Cl. CPC B32B 27/08; B32B 7/12; B32B 27/12; B32B 2307/554

(57) ABSTRACT

A process for manufacturing a floor or wall covering is provided. The floor or wall covering has at least one base layer (2) that is made of polymer materials and has an upper face (2a) and a lower face (2b), the upper face having a predefined relief pattern. process including at least the steps of a) advancing the base layer (2); b) controlling numerical control deposition means to deposit a fluid adhesive material (4a, 4b) on the upper face (2a) of the base layer (2) according to the predefined relief pattern; c) depositing material particles (3a, 3b) on the fluid adhesive material (4a, 4b); and d) crosslinking the deposited fluid adhesive material (4a, 4b) to bond the material particles (3a, 3b) to the base layer (2) and form the predefined relief pattern.

### TECHNICAL FIELD

The present invention relates to the technical field of floor and wall coverings that are made of polymer materials and their manufacturing processes. The invention relates more specifically to processes for manufacturing polyvinyl chloride or similar coverings, and more specifically, to coverings having at least one layer having a relief surface.

### PRIOR ART

In the field of floor or wall coverings, slabs, slats or rollers comprising at least one plastic material layer, for example, obtained from polyvinyl chloride (PVC) are well known. Known processes for manufacturing such floor coverings generally comprise a first step of depositing a first layer of granules of plastic material on a support, then in melting and pressing by means of a double-band plate press, or with a passage between two cylinders of a calender, this layer in order to bond the granules and to obtain a decorative floor covering layer. A floor or wall covering can also comprise a decorative layer in the form of a printed film protected by a transparent or translucent layer, the decorative layer being disposed in the upper part of the floor covering.

These floor coverings thus have imitating, even realistic, decorations. To improve the visual and tactile rendering of these coverings or provide them with non-slip properties, there are processes for graining the upper face of these coverings. These processes make it possible to provide the covering with a predefined relief pattern. Mechanical graining processes use, for example, cylinders having protrusions or cavities according to a predefined pattern and making it possible to apply the imprint of this relief pattern by cold or hot pressure on the surface of the covering. There are other processes by adding material, such as, for example, the process described in patent EP2108524 consisting of applying superposed varnish layers by inkjet printing to form a relief on the surface of panels.

These different processes for obtaining reliefs are not, however, satisfactory in terms of flexibility, the cylinder changes being long and expensive, or depth of relief obtained, even abrasion resistance. On the other hand, mechanical graining processes using graining cylinders are difficult to superpose on a printed decoration in a recorded manner and are repeated rapidly. Indeed, the relief pattern cannot be longer than the developed length of the cylinder, generally less than three metres.

### SUMMARY OF THE INVENTION

One of the aims of the invention is to overcome the disadvantages of the prior art, in particular by proposing a process for manufacturing a floor or wall covering comprising at least one base layer that is made of polymer materials comprising an upper face and a lower face, said upper face comprising a predefined relief pattern, the pattern being easily modifiable, with no length limit and being able to have a significant depth.

A second aim of the invention is to propose a process for manufacturing a floor or wall covering having a base layer having a decorative pattern, in the thickness of the base layer or on a printed film, the pattern being predefined, and a second relief pattern, the second relief pattern being predefined and preferably recorded at the position of the decorative pattern.

To this end, a process has been developed for manufacturing a floor or wall covering comprising at least one base layer that is made of polymer materials and comprising an upper face and a lower face, said base layer comprising a predefined relief pattern, the process involving at least the steps of:
a) advancing the base layer;
b) controlling numerical control deposition means to deposit a fluid adhesive material on the upper face of the base layer according to the predefined relief pattern;
c) depositing material particles on the fluid adhesive material;
d) crosslinking the deposited fluid adhesive material to bond the material particles to the base layer and form the predefined relief pattern.

This process thus makes it possible to obtain a relief on the upper face of the base layer, the relief being obtained by the combination of the predefined relief pattern obtained by the distribution of the material particles and the crosslinked fluid adhesive material.

Advantageously, the steps of depositing the fluid adhesive material and of depositing the particles can be repeated in order to obtain a more complex relief pattern.

A support is generally used to support and advance the base layer. The support only serves to obtain the floor or wall covering and is then disconnected from the covering. The support can, for example, comprise a continuous conveyor belt, for example, a metal belt, or a transfer paper, for example a paper coated with a silicone layer on the face intended to receive the base layer, or also a textile which does not bond to the material of the base layer.

The base layer is made of polymer materials and can be presented in the form of a monolayer or a multilayer structure. The lower face of the base layer can optionally be subsequently bonded to other layers, so as to form a heterogeneous floor covering and to provide, for example, other damping, resistance or acoustic properties to the covering. In particular, a base layer can be obtained from PVC and can, for example, be made by calendering, coating then gelling, by pressing or also by extrusion through a flat die, this layer being presented in the form of a sheet having two smooth upper and lower faces.

The numerical control deposition means making it possible to deposit the fluid adhesive material can, in particular, be digital inkjet printing equipment and processes making it possible to deposit drops of fluid adhesive material on the upper face of the base layer according to a predefined relief pattern and according to coordinates obtained from a digital file representing the relief pattern.

Alternatively, numerical control deposition means making it possible to deposit the fluid adhesive material can be any means comprising at least one adhesive material reservoir and at least one deposition nozzle in communication with the reservoir for depositing the fluid adhesive material according to coordinates obtained from a digital file representing the relief pattern. The fluid adhesive material is advantageously deposited, discarded or sprayed in drops having a volume of between 1 picolitre and 1 millilitre. The fluid adhesive material can, in particular, be a varnish, in particular, acrylic-or polyurethane-based, a liquid adhesive, a plastisol.

Once the fluid adhesive material has been deposited, the step of depositing material particles on the fluid adhesive material can be carried out using any known means such as hoppers, sprinklers or other deposition means, in bulk or in a controlled manner. Following the deposition step, it can be considered to carry out a step of removing, in particular by suction or blowing, of the particles not having been deposited on the adhesive material and remaining free, so as not to degrade the final visual appearance of the covering.

Alternatively, step c) comprises a step of controlling numerical control deposition means to deposit material particles on the fluid adhesive material according to the predefined relief pattern. This alternative makes it possible to limit the quantity of particles to be deposited and to refrain from a step of removing particles not bonded to the adhesive material. Indeed, despite the removal step, particles can pollute the desired relief pattern by remaining positioned at an undesired position.

The polymer materials being able to be used in the composition of the base layer and of the material particles deposited to form the relief pattern are, for example, polyvinyl chloride (PVC), polyvinyl butyral (PVB), PLA or polylactic acid, thermoplastic polyurethane (TPU), polypropylene (PP), polymethyl methacrylate acrylic (PMMA), cellulose derivatives, elastomers, individually or in mixtures. The material particles deposited to form the relief pattern can also comprise at least one mineral, natural or synthetic filler.

The material particles deposited to form the relief pattern can also comprise at least one plasticiser. They can be coloured, transparent or translucent.

The material particles deposited to form the relief pattern can be from a recycling die.

The material particles deposited to form the relief pattern can have a spherical and/or ovoid shape to improve the flowability and fineness of the pattern, as well as its repeatability. Indeed, particles of coarse shape such as particles obtained by grinding post-consumer products or others do not flow homogeneously and can induce variability during the deposition step. In particular, spherical and/or ovoid particles can be obtained by well-known extrusion processes through a hole die with underwater blade cutting. Advantageously, the material particles deposited to form the pattern are particles that are made of polymer materials such as PVC, polypropylene, polyethylene, PMMA, linoleum, thermosets, individually or in a mixture or from non-polymer materials such as corundum, glass, natural mineral particles such as mica, quartz, basalt, etc.

Advantageously, the particles are granules having a particle size of between 0.5 mm and 10 mm or also powders with a particle size of between 2 μm and less than 500 μm, preferably between 20 μm and 250 μm. Said particles can also comprise a mixture of granules and powders. Due to the variety of particles which can be used with the process according to the invention, it is thus possible to obtain reliefs having a significant depth of several millimetres and also a very fine resolution, up to a few microns.

The material particles deposited to form the relief pattern can also be presented in the form of a PVC dry-blend or in the form of granules obtained from a gelled polymer material such as PVC. The material particles deposited to form the pattern can be presented in the form of coloured granules, each granule comprising one or more colours.

Several means make it possible to partially or totally crosslink the deposited fluid adhesive material to bond the material particles to the base layer and form the predefined relief pattern. Known means are in particular drying, enabling the evaporation of the liquid part of the adhesive material without causing deformation of the base layer. In particular, drying can be carried out using a flow of hot air. Other means make it possible to partially or totally crosslink the fluid adhesive material, in particular, the exposure of the material to infrared and/or near-infrared radiation.

Alternatively, in the case where the composition of the fluid adhesive material comprises photoinitiators, this can be partially or totally crosslinked by exposure to ultraviolet or excimer radiation or to an electron beam.

The process according to the invention can be carried out step by step, i.e. That after each manufacturing of a relief pattern, the base layer coated with the relief pattern is moved relative to the deposition means and a new base layer is moved towards the deposition means to be coated with the relief pattern. By “advancing”, this means that the base layer is moved relative to the means for depositing the adhesive material and the particles and/or that the means for depositing the adhesive material and the particles are moved with respect to the base layer.

Alternatively, and so as to make the process more rapid and less expensive, the process for manufacturing a floor or wall covering according to the invention can be carried out continuously. To this end, the base layer advances continuously relative to the means for depositing the adhesive material and the particles, for example, at a speed of between 1 and 25 metres per minute, advantageously between 5 and 12 metres per minute. For example, it is possible to advance a support in the form of a continuous belt supporting a base layer provided as a roller and unwound continuously by the advancing of the support. It is also possible to advance a support in the form of a continuous belt supporting a series of base layers provided as a slat, plate or slab, and advancing continuously, thanks to the advancing of the support.

Alternatively, the base layer can be manufactured continuously by any known means such as calendering, coating then gelling, pressing or also by extrusion through a flat die, and deposited continuously on the continuously advancing support.

It is also possible to deposit the adhesive material in several stages, or even to use several adhesive materials. To this end, the process according to the invention can involve the following steps of:
controlling numerical control deposition means to deposit a first fluid adhesive material on the upper face of the base layer according to a first part of the predefined relief pattern;
controlling numerical control deposition means to deposit at least one second fluid adhesive material on the upper face of the base layer according to a second part of the predefined relief pattern.

In this manner, it is possible to obtain a floor covering having a relief pattern obtained from at least two parts of the predefined pattern and therefore more complex than a pattern made in one go. The first and second fluid adhesive material can be identical or different. In particular, the adhesion properties of the fluid adhesive material to the upper face of the base layer and/or to the material particles can be adapted according to the first and the second part of the pattern. Likewise, the surface appearance or also the colour of the first and/or second fluid adhesive material can be different, in order to obtain a significant richness of the relief pattern.

It is also possible to use several particle types in the process according to the invention. To this end, the process according to the invention can involve the following steps of:
controlling numerical control deposition means to deposit a first type of material particles on the fluid adhesive material according to a first part of the predefined relief pattern;
controlling numerical control deposition means to deposit a second type of material particles on the fluid adhesive material according to a second part of the predefined relief pattern.

In this configuration, several configurations can be considered. According to a first option, the step of depositing the first particle type can be carried out on a part of the fluid adhesive material itself deposited according to the entire relief pattern. It is not necessary that only some of the fluid adhesive material has been deposited, the numerical control deposition means enabling a selective deposition of the particles according to a first part of the pattern.

According to a second configuration, the step of depositing the first particle type can be carried out on the fluid adhesive material itself deposited according to a first part of the relief pattern.

The same applies to the step of depositing the second particle type on the fluid adhesive material, itself deposited according to all or some of the predefined relief pattern.

The step of crosslinking the first fluid adhesive material can be carried out after the step of depositing the first particle type or after the step of depositing the second particle type.

In this manner, it is possible to obtain a floor covering having a relief pattern obtained from at least two parts of the predefined and therefore more complex relief pattern. The first and second material particle types are preferably different, in particular in terms of adhesion property to the fluid adhesive material, mechanical properties, size, shape, abrasion resistance, colour, composition, gloss, transparency, etc.

Optionally, the process according to the invention comprises additional steps after step c) or d) of:
coating a protective layer on the material particles, such that the material particles are partially embedded in the thickness of the protective layer;
crosslinking the protective layer.

The protective layer is a layer being able to be transparent, translucent or coloured, obtained from a varnish, a PVC plastisol or also a “hot coating”. This protective layer makes it possible to improve resistance to abrasion, scratching and traffic. The deposited particles can be partially embedded in the thickness of the protective layer, such that at least some of the particles are flush with the surface of the protective layer.

Alternatively, the deposited particles can be covered with the protective layer, such that this moulds the shape of the relief pattern. This makes it possible to preserve a very weakly structured surface relief, while improving cleanability and protecting the deposited particles.

Optionally and finally to improve the visual appearance and the richness of the decoration presented by the covering, the process according to the invention involves at least one additional step of:
printing a predefined decorative pattern on the upper face of the base layer (2) and/or on the material particles using an inkjet printing process.

The base layer can therefore, prior to the step of depositing the fluid adhesive material, have been printed with a decorative pattern by any known means, in particular by an inkjet printing process. The base layer can also comprise, in its thickness, a decorative layer which can be seen from the upper face of the base layer. It is thus possible that the base layer comprises, from the upper face to the lower face, a translucent or transparent layer, a decorative layer, a backing layer. It is also possible that the base layer comprises, from the upper face to the lower face, a decorative layer and a backing layer. The decorative layer can be obtained by any known means, in particular by an inkjet printing process, on a support film or on the backing of a translucent layer or directly on the backing layer.

It is also possible that all or some of the material particles are printed with a decorative pattern, preferably after the step of crosslinking the fluid adhesive material, by any known means, in particular by an inkjet printing process. This makes it possible, in particular, to bring nuances to the relief, such as veins of a wood, details of colours, geometric patterns, superimposed on the particles.

Alternatively, the base layer is made of particles of polymer materials in the form of granules and/or powders and/or dry blends agglomerated according to a predefined decorative pattern. Said base layer thus comprises material particles that are distributed to form a predefined decorative pattern.

This alternative of the process thus makes it possible to obtain a covering comprising a decoration in the thickness of the base layer, this being obtained by the combination of the pattern obtained by the distribution of the polymer material particles in the form of distributed granules and/or powders and/or dry blend and possible other materials of the base layer.

According to the embodiments where the base layer comprises at least one decorative layer having a predefined decorative pattern in the thickness or a predefined decorative pattern printed on the upper side of the base layer or a predefined decorative pattern printed on a decorative layer comprised in the base layer, the process according to the invention can involve a step of:
depositing the fluid adhesive material according to the position of the predefined decorative pattern.

This alternative makes it possible to record the relief pattern with the decorative pattern to bring more realism to the covering. Thus, a relief can be brought to the right of a printed decorative pattern to accentuate it. Alternatively, the parts having a decorative pattern cannot be covered with a relief pattern, this accentuating, for example, parts adjacent to the printed decorative pattern.

Preferably, the fluid adhesive material can be crosslinked in several steps, so as to pre-crosslink it and/or hold it on the base layer, for example, by exposure under infrared radiation. To this end, the process can involve at least one additional step after step c) of partially crosslinking the deposited fluid adhesive material. This makes it possible, in particular, to provisionally hold the particles to be able to move the base layer, or also to more easily deposit a second adhesive material and/or particle type.

Following the step of crosslinking the fluid adhesive material, a step of heating the particles and/or pressing can be carried out. This can make it possible to slightly modify the appearance of the particles or to push them slightly into the thickness of the layer to hold them better, while preserving a relief pattern flush with the upper face of the base layer. This step can be carried out using a furnace, by exposure to infrared or near infrared radiation, a hot or cold press, pressure cylinders.

The invention also relates to a floor or wall covering comprising at least one base layer comprising a predefined relief pattern obtained by a manufacturing process according to the invention such as described. The covering thus comprises a predefined relief pattern.

Whatever the embodiment, the particle deposition means can comprise at least one particle storage means comprising at least one outlet, for example a hopper, as well as at least one closure means for each outlet controllable by numerical control, so as to stop or let the particles flow in a controlled manner. Each particle deposition means can, for example, comprise a particle type, a colour for example, so as to mix several types of particles in the pattern using several deposition means.

Whatever the embodiment, the means for depositing the particles can comprise numerical control means, the pattern being predefined in a digital file or any equivalent computer storage means. The numerical control means comprise means for interpreting said file or computer storage means for numerically controlling the deposition means according to the relief pattern and depositing the particles according to the relief pattern.

### BRIEF DESCRIPTION OF THE DRAWINGS

FIG. 1A is a side view of a first example of a covering obtained by a process according to the invention.

FIG. 1B is a detailed view of the first example of a covering according to FIG. 1A.

FIG. 2 is a side view of a second example of a covering obtained by a process according to the invention.

FIG. 3 is a side view of a third example of a covering obtained by a process according to the invention.

FIG. 4 is a side view of a fourth example of a covering obtained by a process according to the invention.

FIG. 5 is a side view of a fifth example of a covering obtained by a process according to the invention.

FIG. 6 is a side view of a sixth example of a covering obtained by a process according to the invention.

FIG. 7 is a side view of a seventh example of a covering obtained by a process according to the invention.

FIG. 8 is a perspective view of a device enabling the implementation of a process according to the invention.

FIG. 9 is a top view of the distribution device for the numerically controlled distribution of particles, presented in FIG. 8.

FIG. 10 is a side view of a second device enabling the implementation of a process according to the invention.

### DETAILED DESCRIPTION OF THE INVENTION

Whatever the embodiment, the material particles being able to be distributed are in bulk, for example, in the form of powders and/or granules and/or “dry blend”. The granules being able to be used for manufacturing the relief according to the invention, can be identical or of different natures. As an example, the polymer materials being able to be used can be chosen from among PVC, pure PVC or plasticised PVC, PP, PE, PMMA, as well as product offcuts or grindings coming from recycling channels of these materials. It is naturally possible to mix several types of materials to be deposited to obtain a relief pattern according to the invention. As non-limiting examples, the materials being able to be deposited can be granular materials in the form of powders, granules, grit, flakes, strips or any other materials in particulate or substantially particulate form. More specifically, these can be pearls, pigments, pure or coated in the form of pigment paste, non-slip particles. The particles can also comprise linoleum, linoleum paste also called “linoleum cement”, thermosets, inorganic particles, such as glass or corundum, natural mineral particles such as mica, feldspar, basalt, glass particles or hollow polymers, etc.

The particles can optionally be slightly pressed to penetrate into the thickness of the base layer without, however, penetrating fully, and so as to preserve at least one part flush with the predefined relief pattern. They can also be heated before and/or after deposition to slightly modify their surface appearance or assist with their adhesion to the fluid adhesive material.

In the case of PVC, this can be used in different forms for the manufacture of particles in the form of granules. As an example, the granules are obtained from PVC, optionally with a filler, optionally with plasticiser, mixed, then gelled in a mixer. A conventional process for obtaining plasticised granules involves at least the steps of:
heating a quantity of powdered PVC between 60° C. and 90° C., then adding to it a quantity of plasticiser;
heating the mixture obtained up to around 100° C.-110° C., such that the PVC is plasticised and optionally incorporating a quantity of filler, stabilisers, pigments or other additives, and mixing;
cooling the plasticised PVC mixture to incorporate a quantity of filler, stabilisers, pigments or other additives, and mixing. The resulting mixture is presented in the form of a powder called “dry blend”;
gelling this “dry blend” by heating it to 170° C. in a continuous extruder, or in batches in an “internal” mixer;
extruding the mixture through a hole die, then cutting the molten material beads, in order to obtain granules from 0.5 to 5 millimetres of cross-section, and of a length of 0.5 to 10 millimetres.

According to an alternative, the material particles that are distributed according to the invention are in the form of powder, even “dry blend”, i.e. in the form of polymer material powder, for example, PVC, plasticised and non-gelled. In this case, the process according to the invention involves a step of depositing the particles in the form of a “dry blend” on the fluid adhesive material, itself deposited according to a predefined relief pattern, then of gelling this “dry blend”, for example, by heating. Using dry blend makes it possible to obtain a better relief resolution with regard to the particle size being able to be obtained with this powder type. Preferably, and so as to facilitate its handling by the deposition means, the powder deposited has a particle size of between 2 μm and 250 μm. As an example, a dry blend commonly used for preparing PVC granules has a density of around 0.50, a volume mean diameter of 136 μm, a D50: 140 μm, a 63 μm D10 and a 198 μm D90 . Using dry blend also makes it possible to remove the granulation step commonly used for manufacturing PVC floor covering, by making it possible to directly manufacture a relief pattern. This granulation operation is expensive in time, equipment and energy. The distribution of a dry blend is also facilitated with respect to that of granules which generally have a wider particle size distribution. It is thus easier to obtain a homogeneous deposition in thickness.

In the case of linoleum, it is possible to adapt the process according to the invention in order to obtain a pattern from a distribution of linoleum paste. A linoleum paste is presented in powder form obtained from a mixture of linoleum cement mixed with cork powder, wood flour and dyestuffs, such as pigments. The process thus involves an additional step of heating the particles comprising the linoleum paste, so as to crosslink this paste and obtain the relief pattern. The particles can optionally be slightly pressed to penetrate into the thickness of the base layer without, however, penetrating fully, and so as to preserve at least one part flush with the predefined relief pattern.

The base layer according to the invention generally has a thickness of between 0.3 and 6 millimetres.

The base layer is made of polymer materials and can be presented in the form of a monolayer or a multilayer structure. The lower face of the base layer can optionally be subsequently bonded to other layers, so as to form a heterogeneous floor covering and provide, for example, other damping, resistance or acoustic properties to the covering. In particular, a base layer can be obtained from PVC and can, for example, be manufactured by calendering, covering, then gelling, by pressing or also by extrusion through a flat die, this layer being presented in the form of a sheet having two smooth faces.

The base layer can form a floor or wall covering in rolls or even be cut to form a floor covering in plates, slabs or also slats. Rolls can have a dimension of between 5 and 50 metres long and between 1 and 4 metres wide.

In particular, assembly means can be machined on the edges of each slab or slat, in order to bond them together. Such means are described, in particular, in documents WO2016030627, US20130309441 or also EP3105392. Plates, slabs or slats can have a dimension of between 0.10 and 3.5 metres long and 0.10 and 2.6 metres wide.

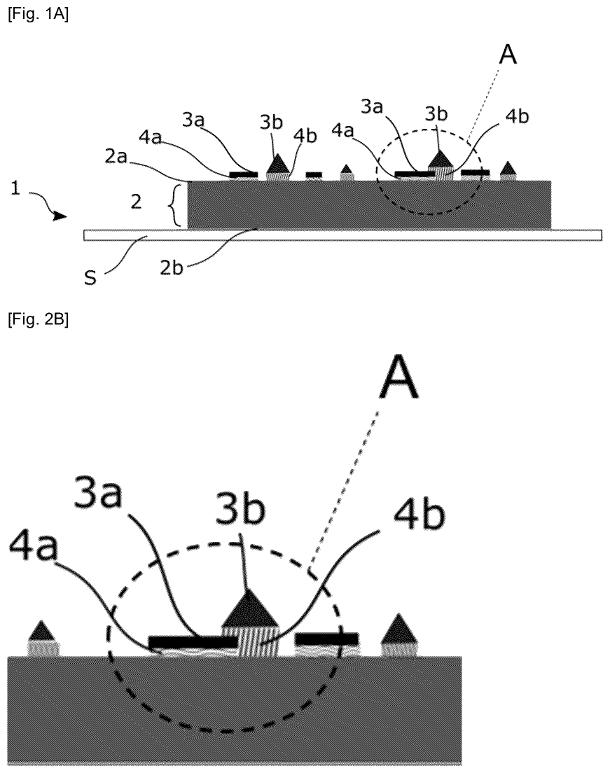

According to FIG. 1A, a first example of a floor or wall covering (1) comprising a base layer (2) advancing on a support(S) is described. The base layer (2) has an upper face (2a) and an opposite lower face (2b) intended to be in contact with the floor. On the upper face (2a), a first fluid adhesive material (4a) is deposited by numerical control, according to a part of a predefined relief pattern. Material particles (3a) of a first type are then deposited on the fluid adhesive material (4a). The fluid adhesive material (4a) is then crosslinked, such that the covering formed only preserves the dry part of the adhesive material (4a). FIG. 1B illustrates a detail A of FIG. 1A showing an overlap between two particle types (3a, 3b). To achieve this overlap, the fluid adhesive material (4b) is deposited according to a second part of the predefined relief pattern after the step of depositing the particles (3a). This step occurs before or after the step of crosslinking the fluid adhesive material (4a). After depositing the second particle type (3b), the adhesive material (4a, 4b) is fully crosslinked. The material particles (3a, 3b) are thus bonded to the base layer (2), so as to form the predefined relief pattern. The fluid adhesive material (4a, 4b) can be applied in one or more deposition steps, each deposition also being able to be carried out according to a new predefined relief pattern and/or with a new fluid adhesive material type (4a, 4b). On the other hand, the particles (3a, 3b) can be deposited in one or more deposition steps, each deposition optionally being carried out according to a new predefined relief pattern in relation to the relief pattern of deposition of at least one fluid adhesive material and/or with a new particle type (3a, 3b).

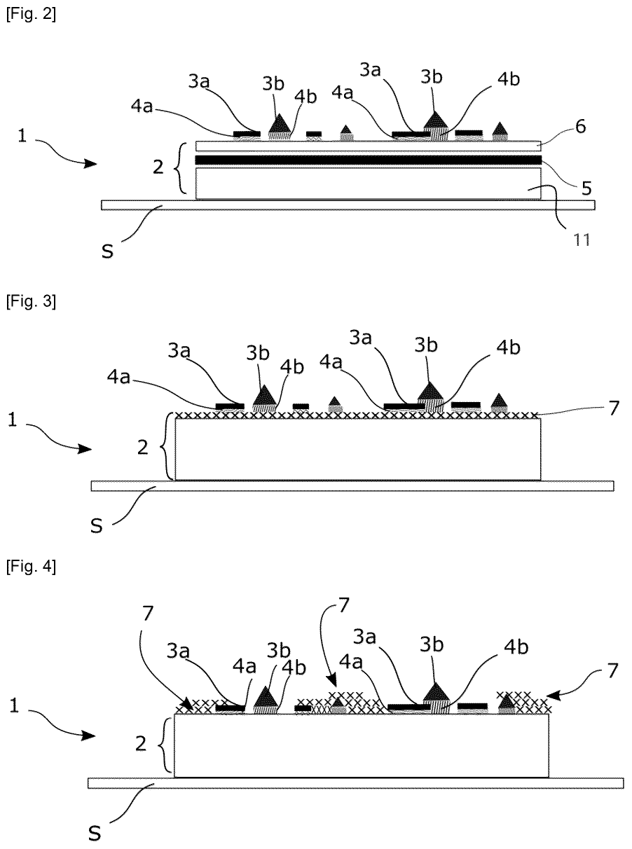

According to FIG. 2, a second example of a floor or wall covering (1) is described having a base layer (2) showing the elements of FIG. 1A and also comprising at least one decorative layer (5) printed with a predefined decorative pattern, by any known means, in particular, by an inkjet printing process, and which can be seen from the upper face of the base layer (2a). The base layer (2) optionally comprises a translucent or transparent layer (6) bonded on the decorative layer (5). The decorative layer (5) is therefore optionally covered with a translucent or transparent layer (6) in order to protect it. Thus, in this example, the upper face (2a) of the layer (2) is either formed by the upper face of the decorative layer (5) or by the upper face of the translucent or transparent layer (6). The fluid adhesive material (4a, 4b) is thus either deposited on the printed pattern or on the translucent or transparent layer (6). The base layer (2) thus comprises a decorative layer (5) bonded to a backing layer (11) intended to be in contact with the floor. The decorative layer (5) is, for example, a PVC film with a thickness of between 50 and 150 μm.

According to FIG. 3, a third example of a floor or wall covering (1) comprising a base layer (2) showing the elements of FIG. 1A and having a predefined decorative pattern (7) printed on the upper face of the base layer (2a) is described.

According to FIG. 4, a fourth example of a floor or wall covering (1) is described, having a base layer (2) showing the elements of FIG. 1A and having a predefined decorative pattern (7) printed on the superimposed particles (3a, 3b).

The pattern (7) of FIGS. 3 and 4 can be printed by any known means, in particular by inkjet printing processes. The ink types used can, in particular, be water-or latex-based inks, and can be dried or crosslinked by any known means, in particular, by hot air flow or by exposure to ultraviolet radiation.

According to FIGS. 2, 3 and 4, in the case where the base layer (2) comprises at least one decorative layer (5) having a predefined decorative pattern or a predefined decorative pattern (7) printed on the upper face of the base layer, the fluid adhesive material (4a, 4b) can be deposited according to the position of the predefined decorative pattern.

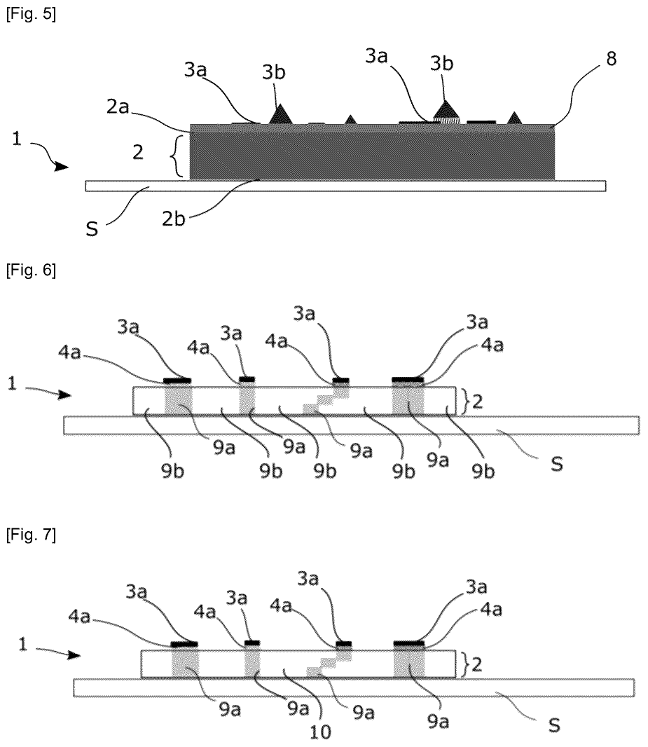

According to FIG. 5, a fifth example of a floor or wall covering (1) is described, having a base layer (2) showing the elements of FIG. 1A and having a crosslinked protective layer (8), previously deposited on the material particles (3a, 3b), such that the material particles (3a, 3b) are partially embedded in the thickness of the protective layer (8). At least some the particles are flush with the surface of the protective layer (8). Alternatively, and in a manner not represented, the deposited particles can be covered with the protective layer, such that this moulds the shape of the relief pattern. This makes it possible to preserve a very weakly structured surface relief, while improving cleanability and protecting the deposited particles (3a, 3b). In the case where the base layer (2) and/or the material particles (3a, 3b) are printed with a decorative pattern (7), the protective layer (8) can be deposited on the decorative pattern (7) in order to protect it. Alternatively, and in a manner not represented, the protective layer (8) can be deposited on the material particles (3a, 3b), then printed with a decorative pattern (7) by any known means.

According to FIGS. 6 and 7, a sixth and seventh example of a floor or wall covering (1) is described. In these examples, the base layer (2) can comprise polymer material particles (9a, 9b) that are distributed by numerical control deposition means to form a decorative pattern along the three axes of a three-dimensional system (X, Y, Z) and so as to be distributed in all or some of the thickness of the base layer (2). The base layer is thus obtained at least partially, even fully from particles that are distributed by numerical control deposition means before the step of depositing the fluid adhesive material (4a). According to FIG. 7, the polymer material particles (9b) making it possible to obtain a predefined decoration, can be deposited in a polymer matrix (10), for example, a plastisol or a powder layer. The polymer particles (9b) can optionally be substituted by non-polymer particles in the case of using a polymer matrix (10). A process for manufacturing a floor or wall covering having a base layer (2) according to this example, is made of polymer materials, said base layer comprising material particles that are distributed to form a predefined pattern involves at least the steps of:
controlling numerical control deposition means to deposit the material particles (9a, 9b) on a continuously or step-by-step advancing support (S) to form the predefined decorative pattern, or, controlling numerical control deposition means to deposit the material particles (9a) on a polymer matrix (10) supported by the support (S) and continuously or step-by-step advancing to form the predefined decorative pattern;
heating the material particles (9a, 9b) and, if necessary, the polymer matrix (10) to bond same and form the base layer (2);
optionally, pressing the material particles (9a, 9b) and, if necessary, the polymer matrix (10).

The polymer material particles (9a, 9b) used to obtain the layer (2) according to FIGS. 6 and 7 can be presented in the form of powders, for example, of PVC “dry blend”, coloured or not, even of gelled PVC granules, individually or in mixtures. According to the material type, it can be necessary to carry out a hot pressing step of the deposited particles to obtain a base layer (2) of homogeneous thickness.

Generally, the step of controlling numerical control deposition means to deposit material particles on a support to form the pattern, can be carried out by a device for numerically controlled distribution of material particles, such as granules and/or powders. As an example, this device can comprise at least one particle storage hopper having at least one outlet. The outlet being able to be closed or opened by numerical control, so as to let the particles stored in the hopper flow on a support in a controlled manner and according to a predefined pattern.

Several processes and devices make it possible to deposit particles according to a predefined relief pattern according to the invention.

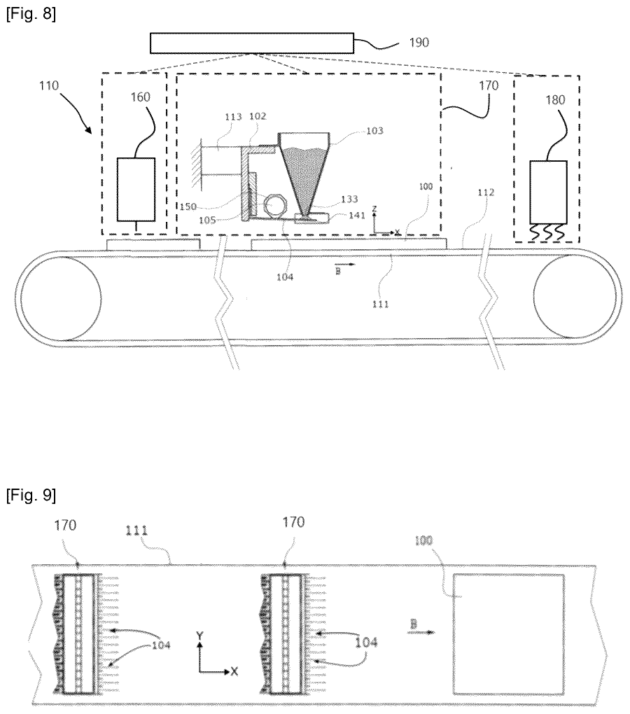

FIGS. 8 and 9 illustrate an examples of an implementation of a device (110) being able to implement a process according to the invention. The base layer (100) is illustrated, in this case, in the form of plates, although the same device (110) can be used for roll products. The base layer (100) is supported by a support (111) and advances continuously or step by step. The device also comprises means for advancing the support (111) to carry out a relative movement in at least one advancing direction (B) between a distribution device (170) and the base layer (100) on which the particles must be distributed. The support (111) is, in this case, a continuous conveyor belt (111) transporting the base layer (100), the belt being driven by an electronically controlled motor.

The device (110) comprises at least one device (160) for depositing a fluid adhesive material on the upper face of the base layer (100) according to a predefined relief pattern.

The device (110) also comprises at least one deposition device for the numerically controlled distribution of particles (170), in which each deposition device (170) comprises a hopper (103) for storing bulk material provided with a plurality of outlets (133), a plurality of distribution elements (104), each being located facing an outlet (133), such that the material exiting each outlet (133) can accumulate in there without flowing. Each distribution element (104) is inclined with respect to a horizontal plane, in order to define a direction of sliding of the particles towards at least one descending edge (141) of the distribution element (104). The device (170) also comprises several vibrating means (105, 150), each being associated with a respective distribution element (104) for vibrating said distribution element (104), such that the accumulated particles slide upwards on the distribution element (104) until the particles fall from the descending edge (141) of the latter, when this is vibrating on the base layer (100).

The distribution elements (104) are inclined at an inclination of between 0° and 10° with respect to the horizontal plane.

The device (110) also comprises at least one means (180) for crosslinking the fluid adhesive material, for example, a hot air dryer or an infrared lamp.

Numerical control means (190) control the deposition device (160) according to a known predefined pattern of the control means (190), the distribution device for the numerically controlled distribution of particles (170), in particular for the activation of each vibration means (105, 150), independently of one another, as well as the means making it possible to crosslink the fluid adhesive material (180). Numerical control means (190) can, in particular, be a control/command computer, a microcontroller comprising means for digitally storing a file defining the predefined relief pattern.

The devices for depositing the fluid adhesive material (160), depositing the particles (170) and crosslinking (180) are stably fixed to a fixed support (113, 102) with respect to the support (111). As illustrated in FIG. 9, a plurality of devices (170) can be disposed transversely to the support (111). In this manner, each distribution device (170) can act in sequence on the base layer (100), in order to increase the range of reliefs and/or decorative effects which can be achieved. In particular, the hoppers (103) of the distribution devices (170) can be filled with particles having a different colour, density, hardness, gloss, with the aim of obtaining predefined patterns and/or textures and having several colours and/or materials. Thus, each distribution device (170) is intended to deposit a specific material, for example a colour, on the base layer (100) according to a predefined pattern.

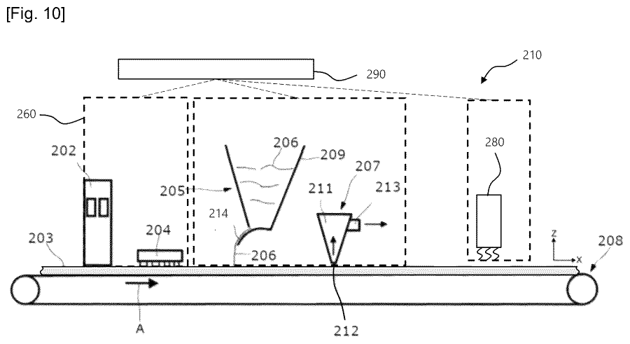

FIG. 10 illustrates a second example of a device (210) being able to implement a process according to the invention. The base layer (203) is illustrated, in this case, in roll form, although the same device (210) can be used for plate products. The base layer (203) is supported by a support (208) and advances continuously or step by step. The device also comprises support advancing means for achieving a relative movement in at least one advancing direction (A) between a distribution device (205) and the base layer (203) on which the particles must be distributed. The support (208) is, in this case, a continuous conveyor belt transporting the base layer (203) and driven by an electronically controlled motor.

This device (210) makes it possible to manufacture predefined relief patterns by numerical control from materials in the form of particles. It comprises means for depositing by numerical control, fluid adhesive material (260) from a digital printhead (202) provided with piezoelectrically controlled ejection nozzles. The digital printhead (202) can also be provided with several respective individual heads, each equipped with nozzles for ejecting fluid adhesive material on the upper face of the base layer (203). The means (260) thus enable the ejection of microdrops of fluid adhesive material onto the surface of the base layer (203). Optionally, the means (260) comprise radiating means (204) adapted to irradiate the drops of fluid adhesive material deposited in the case where this can be hardened by exposure to radiation. It is, for example, possible to define a fluid adhesive material, for example, a varnish, such that the irradiation of the fluid adhesive material, for a predefined period and quantity of energy, enables a pre-crosslinking of it. By a rapid transformation into a substantially transparent film similar to glue, it is thus possible to subsequently deposit material particles on the adhesive material and to obtain a first level of bonding before total crosslinking of it. The device (210) thus comprises means (205) for depositing material particles (206) on the adhesive material layer, after this has undergone irradiation under the radiating means (204) and has thus taken on a consistency similar to glue. The means (205) for depositing the material particles comprise, for example, a hopper (209) opening onto a closable outlet (214) which, in the open position, lets the particles stored in the hopper (209) to flow regularly. The means (205) extend transversely over all or some of the width of the base layer (208) along the Y axis. The device (210) optionally comprises means (207) for removing excess material particles (206), which are deposited on the base layer (203) without being bonded to the fluid adhesive material. These means (207) make it possible to remove the material particles (206) which have not bonded directly to the adhesive material, and which therefore remain in excess, since they cannot be incorporated into the relief pattern being manufactured. The means (207) for removing excess material particles (206) comprise, for example, at least one suction hood (211) disposed such that is suction mouth (212) is close to the upper surface of the base layer (203) supported by a continuous belt conveyor (208). The suction hood (211) can also comprise a discharge mouth (213) through which, through suitable conduits, not represented in the figures, the excess material particles (206) can be returned to the inside of the hopper (209), or conveyed to a special collection zone.

The base layer (203) is disposed on the continuous belt conveyor (208) and advances in a direction A continuously or step by step.

The device (210) also comprises at least one means (280) for total crosslinking of the fluid adhesive material, for example, a hot air dryer or an infrared lamp.

Numerical control means (290) control the means for depositing the fluid adhesive material (260) according to a predefined pattern known to the control means (290), the distribution device for the controlled distribution of particles (205), according to the pattern or not. Likewise, the suction system (207), as well as the means for crosslinking the fluid adhesive material (280) can optionally be controlled by the numerical control means (290). Numerical control means (290) can, in particular, be a control/command computer, a microcontroller comprising means for digitally storing a file defining the predefined relief pattern.

1. A process for manufacturing a floor or wall covering having at least one base layer that is made of polymer materials with an upper face and a lower face, said upper face having predefined relief pattern, said process comprising the steps of:
a) advancing the base layer (2);
b) controlling numerical control deposition means to deposit a fluid adhesive material (4a, 4b) on the upper face (2a) of the base layer (2) according to the predefined relief pattern;
c) depositing material particles (3a, 3b) on the fluid adhesive material (4a, 4b); and
d) crosslinking the deposited fluid adhesive material (4a, 4b) to bond the material particles (3a, 3b) to the base layer (2) and form the predefined relief pattern.

2. The process for continuously manufacturing a floor or wall covering according to claim 1, wherein the base layer advances continuously.

3. The process for manufacturing a floor or wall covering according to claim 1, wherein step b) involves the following steps of:
controlling numerical control deposition means to deposit a first fluid adhesive material on the upper face of the base layer according to a first part of the predefined relief pattern;
controlling numerical control deposition means to deposit at least one second fluid adhesive material on the upper face of the base layer according to a second part of the predefined relief pattern.

4. The process for manufacturing a floor or wall covering according to claim 1, wherein step c) involves the following step of:
controlling numerical control deposition means to deposit material particles on the fluid adhesive material according to the predefined relief pattern.

5. The process for manufacturing a floor or wall covering according to claim 3, characterised in that step c) involves the following steps of:
controlling numerical control deposition means to deposit a first material particle type on the fluid adhesive material according to a first part of the predefined relief pattern;
controlling numerical control deposition means to deposit a second material particle type on the fluid adhesive material according to a second part of the predefined relief pattern.

6. The process for manufacturing a floor or wall covering according to claim 1, wherein said process involves the additional steps after step c) or d) of:
coating a protective layer on the material particles such that the material particles are partially embedded in the thickness of the protective layer;
crosslinking the protective layer.

7. The process for manufacturing a floor or wall covering according to claim 1, wherein the proces involves at least one additional step of:
printing a predefined decorative pattern on the upper face of the base layer and/or on the material particles using an inkjet printing process.

8. The process for manufacturing a floor covering or according to claim 1, the base layer comprises at least one decorative layer having a predefined decorative pattern or a predefined decorative pattern directly printed on the upper face of the base layer, and in that the process involves a following step of:
depositing the fluid adhesive material according to the position of the predefined decorative pattern.

9. The process for manufacturing a floor or wall covering according to claim 1, the process involves at least one additional step after step c) of partially crosslinking the deposited fluid adhesive material.

10. A floor or wall covering comprising at least one base layer, wherein the base layer comprises a predefined relief pattern obtained by a manufacturing process according to claim 1.
